(19) United States
(12) Patent Application Publication
(10) Pub. No.: US 2023/0339574 A1
(43) Pub. Date: Oct. 26, 2023

(54) STEAM ASSISTED AIR SUPPLY SYSTEM FOR A HULL OF A VESSEL AND A VESSEL COMPRISING THE AIR SUPPLY SYSTEM

(71) Applicant: MAERSK A/S, Copenhagen K (DK)

(72) Inventor: Mikkel PREEM, Ballerup (DK)

(21) Appl. No.: 18/028,968

(22) PCT Filed: Oct. 4, 2021
(86) PCT No.: PCT/EP2021/077232

§ 371 Date: Mar. 28, 2023

(30) Foreign Application Priority Data
Oct. 9, 2020 (DK) PA 2020 70685

(51) Int. Cl. B63B 1/38

(52) U.S. Cl. CPC B63B 1/38; B63B 2001/385; B63B 2001/387

(57) ABSTRACT

Disclosed is an air supply system for supplying air to an outside of a hull of a vessel holding a combustion engine. The air supply system comprises one or more air discharge units, ADUs, for releasing compressed air to an outside of the hull below a waterline of the vessel. The air supply system comprises a pump for generating a first flow of sea water. The airs supply system comprises an injector comprising a first inlet for receiving the first flow of sea water from the pump, a second inlet for receiving a second flow of gas from the combustion engine, an outlet for discharging a third flow of gas to the ARUs, and an expansion portion arranged downstream of the first inlet and the second inlet and upstream of the outlet. The injector is configured to mix the first flow of sea water and the second flow of gas into the third flow of gas and the expansion portion is configured to expand the third flow of gas to increase the pressure of the third flow of gas discharged from the injector through the outlet. The air supply system is configured to evaporate the first flow of sea water using thermal energy from the combustion engine so that the third flow of gas is enriched with steam from the first flow of sea water.

The present disclosure pertains to the field of propulsion of vessels. The present disclosure relates to an air supply system for supplying air to an outside of a hull of a vessel and a vessel comprising the air supply system.

### BACKGROUND

A vessel's resistance when moving through water is made up of multiple components, of which frictional resistance is the most dominant. Injection of air into the turbulent boundary layer (between the stationary and moving water) may be used to reduce the frictional resistance of the hull of the vessel in the water.

Air lubrication of the hull can reduce the frictional loss significantly. Depending on the type of propulsion used for the vessel, an efficiency may improve by 5-10% depending on speed, hull form, draft of the vessel and/or a distribution and amount of air to a wetted surface. The draft of the vessel is the vertical distance from the bottom of a keel of the vessel to the waterline.

The total net efficiency improvement depends on the power used to pressurize the air flow required to reduce the friction. Hence, a net propulsion efficiency is to account for power to facilitate an air flow and a given vessel draft pressure.

Traditional air lubrication systems typically use electric compressors to generate air flow. However, electric compressors are expensive, require maintenance and may have poor efficiency.

### SUMMARY

Accordingly, there is a need for an air supply system for supplying air to an outside of a hull of a vessel, which mitigates, alleviates or addresses the shortcomings existing and provides a more efficient air supply system.

Disclosed is an air supply system for supplying air to an outside of a hull of a vessel holding a combustion engine. The air supply system comprises one or more air discharge units, ADUs, for releasing compressed air to an outside of the hull below a waterline of the vessel. The air supply system comprises a pump for generating a first flow of sea water. The airs supply system comprises an injector comprising a first inlet for receiving the first flow of sea water from the pump, a second inlet for receiving a second flow of gas from the combustion engine, an outlet for discharging a third flow of gas to the ADUs, and an expansion portion arranged downstream of the first inlet and the second inlet and upstream of the outlet. The injector is configured to mix the first flow of sea water and the second flow of gas into the third flow of gas and the expansion portion is configured to expand the third flow of gas to increase the pressure of the third flow of gas discharged from the injector through the outlet, such as according to Bernoulli's principle. The air supply system is configured to evaporate the first flow of sea water using thermal energy from the combustion engine so that the third flow of gas is enriched with steam from the first flow of sea water.

It is an advantage of the present disclosure that heat from the engine, which otherwise would be wasted, is used to generate the compressed air flow to be released to the outside of the hull of the vessel. By using an injector, which increases the pressure of the air released to the outside of the vessel by means of the waste heat from the engine without using any moving parts, the efficiency and reliability of the air supply system may be increased.

Disclosed is a vessel comprising a hull, a combustion engine and the air supply system disclosed herein.

It is an advantage of the present disclosure that heat from the engine, which otherwise would be wasted, is used to generate the compressed air flow to be released to the outside of the hull of the vessel. By using an injector, which increases the pressure of the air released to the outside of the vessel by means of the waste heat from the engine without using any moving parts, the efficiency and reliability of the air supply system may be increased. Thus, the efficiency of the vessel may be increased.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 illustrates an air supply system according to one or more examples of this disclosure,

FIG. 2 illustrates an air supply system comprising waste heat recovery elements according to one or more examples of this disclosure,

FIG. 3 illustrates an air supply system comprising waste heat recovery elements and a boiler according to one or more examples of this disclosure, and

FIG. 4 illustrates an air supply system comprising waste heat recovery elements and a boiler and using scavenging air as second gas flow according to one or more examples of this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

An air supply system for supplying air to an outside of a hull of a vessel holding a combustion engine is disclosed. The combustion engine may be a main engine for propulsion of the vessel. The air supply system uses thermal energy from the combustion engine to compress a flow of air to be released to the outside of the hull of the vessel, in order to reduce the friction of the hull of the vessel in the water. The air supply system comprises one or more air discharge units (ADUs), such as air discharge diffusors, for releasing compressed air to the outside of the hull below a waterline of the vessel. The air supply system comprises a pump for generating a first flow of sea water. The air supply system further comprises an injector comprising a first inlet for receiving the first flow of sea water from the pump, a second inlet for receiving a second flow of gas from the combustion engine, an outlet for discharging a third flow of gas to the ADUs, and an expansion portion, such as a diffuser, arranged downstream of the first inlet and the second inlet and upstream of the outlet. The injector is configured to mix the first flow of sea water and the second flow of gas into the third flow of gas and the expansion portion is configured to expand the third flow of gas to increase the pressure of the third flow of gas discharged from the injector through the outlet. The expansion portion comprises a diverging section which slows the third flow down and thereby increases the pressure of the third flow. The kinetic energy of the third flow is converted into pressure energy according to Bernoulli's principle in the expansion portion. This may be considered as the reverse of the process occurring in the nozzle, when the first flow of sea water passes through the nozzle. The pressure of the third flow of gas is increased until it reaches a pressure larger than a discharge pressure at the ADUs. The discharge pressure may correspond to the water pressure from the water surrounding the vessel acting on the air outlet ports. The air supply system is configured to evaporate the first flow of sea water using thermal energy from the combustion engine so that the third flow of gas is enriched with steam from the first flow of sea water. The first flow of sea water may be evaporated in the injector by thermal energy from the second flow of gas. By evaporating the water, a gas mass density of the third flow of gas increases. In other words, additional mass is added to the third flow of gas in the gas phase, which increases the kinetic energy of the third flow of gas. Upon converting the kinetic energy of the third flow of gas into potential energy, the increased kinetic energy of the third flow of gas will be converted to an increased potential energy, such as a higher pressure in the injector. The higher pressure will be able to overcome discharge pressure at the ADUs, due to a head of the water surrounding the vessel.

The injector may be a vacuum injector, a steam injector, and/or a gas/steam injector. The injector may comprise the first inlet, for receiving the flow of sea water, the second inlet for receiving the flow of gas from the engine, a mixing chamber for mixing the flow of sea water and the flow of gas from the engine and a an expansion portion, such as a diffuser, arranged in the outlet section downstream the inlets and the mixing chamber. The first inlet may also be referred to a suction inlet. The first inlet may be a nozzle for accelerating and distributing the water around the second inlet. The second inlet may also be a nozzle, such as a supersonic nozzle having a converging—diverging shape which generates an expansion of the second flow of gas and partially converts enthalpy of the gas into kinetic energy. The injector may use a Venturi effect of the converging-diverging nozzle on a gas or steam jet to convert the pressure energy of the gas or steam to velocity energy, thereby reducing the pressure of the gas to below that of the atmosphere, which enables it to entrain a fluid (such the first flow of sea water). The second inlet may also be referred to as a motion inlet. The mixing chamber may be a chamber having a converging shape. In the mixing chamber, a transportation of heat, mass and momentum occur between the second flow of gas from the engine and the first flow of sea water due to a temperature difference, water evaporation and/or a velocity difference between the second flow of gas and the first flow of sea water. The first flow of sea water and the second flow of gas from the engine are thereby mixed into a third flow of gas. The mixed third flow of gas then enters the expansion portion, such as the diffuser, which slows the third flow of gas, converting the kinetic energy back into static pressure energy above the pressure of the second flow of gas and the first flow of water at the first and second inlets. The diffuser may be a diverging shape section where the kinetic energy of the third flow is partially converted into a further pressure rise.

The injector does not use any moving parts except for a valve for controlling the flow of gas to the injector. The injector has the benefit that it is a simple and reliable solution for increasing the pressure of a fluid.

In one or more example air supply systems according to this disclosure, the gas of the second flow may be an exhaust gas from the combustion engine. The temperature of the exhaust gas may reach up to 700° C. at a maximum load of the engine. The heat of the exhaust gas, which may otherwise be wasted, can thus be used to evaporate the first flow of sea water in the injector.

In one or more example air supply systems according to this disclosure, the gas of the second flow may be a scavenging air for the combustion engine. In one or more example air supply systems according to this disclosure, the air supply system may comprise one or more turbochargers. Each turbocharger may comprise a turbine driven by an exhaust gas flow from the combustion engine and a compressor for generating a compressed scavenging air flow to the combustion engine. Due to the compression of the scavenging air in the turbocharger the thermal energy, such as the heat, of the scavenging air will increase. The heat generated by the compression of the scavenging air can thus be used to increase the efficiency of the air supply system. In order to prevent the turbocharger from overrevving, the air supply system may in some examples comprise an exhaust gas bypass valve for releasing exhaust gas in order to reduce the flow of exhaust gas to the turbocharger.

In one or more example air supply systems according to this disclosure, the air supply system may comprise one or more waste heat recovery (WHR) element(s) arranged in the compressed scavenging air flow downstream of a respective compressor of the one or more turbocharger(s). The heat recovery elements may be configured to increase the temperature of the first flow of sea water by heat exchange with the compressed scavenging air flow before the first flow of sea water is received by the first inlet. Due to the compression of the scavenging air in the turbocharger the thermal energy, such as the heat, of the scavenging air will increase. The heat generated by the compression of the scavenging air can thus be used to increase the efficiency of the air supply system via the waste heat recovery elements.

In one or more example air supply systems according to this disclosure, the air supply system may comprise one or more boilers arranged in the first flow of sea water. The one or more boilers are configured to increase the temperature and/or to evaporate the first flow of sea water by heat exchange with exhaust gas from the combustion engine before the first flow of sea water is received by the first inlet of the injector. The waste heat from the exhaust gas may thus be used to further increase the efficiency of the air supply system, by preheating and/or evaporating the first flow of sea water prior to the first flow of sea water entering the injector.

In one or more example air supply systems, the air supply system may comprise a changeover valve arranged to open and/or close the second flow of gas from the combustion engine. The changeover valve may be used to turn on or off the air supply system, such as the injector of the air supply system.

In one or more example air supply systems, the air supply system may comprise a flow control device arranged to control the second flow of gas from the combustion engine. The flow control device may be an orifice or a control valve. The flow control device may in one or more example air supply systems be a fixed orifice, configured to passively control the gas distribution between the engine and the air supply system. The orifice may be configured to extract a fraction, such as 0-20%, such as 6-10%, of the gas from the engine and provide it to the air supply system. By using an orifice to limit the amount of gas diverted to the air supply system it can be ensured that a sufficient amount of exhaust gas is provided to the turbochargers to provide the required amount of scavenging air to the combustion process in the combustion engine.

In one or more example air supply systems, the flow control device may be variable, such as being a control valve, such as a diaphragm control valve, which can actively control the amount of gas allowed to be extracted to the air supply system. The flow control device may be controlled based on a load of the engine of the vessel, to ensure that the engine receives the required amount of gas for a given load of the engine.

In one or more example air supply systems, the air supply system may comprise a non-return valve configured to prevent gas from flowing back from the injector.

A vessel is further disclosed, the vessel comprising a hull, a combustion engine and the air supply system disclosed herein.

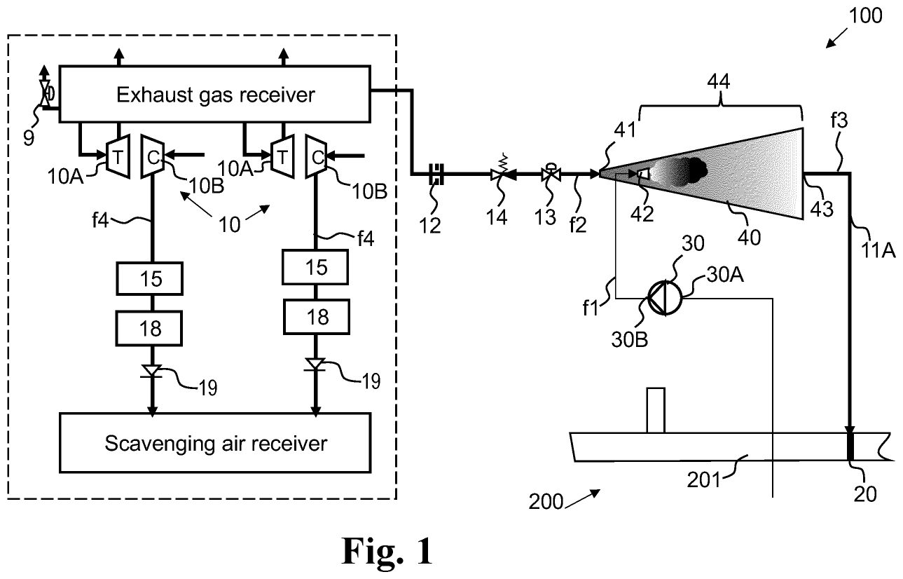

FIG. 1 illustrates an example air supply system 100 for supplying air to an outside of a hull 201 of a vessel 200. The vessel holds a combustion engine (not shown in FIG. 1 but indicated by the box of dotted lines). The scavenging air receiver will provide scavenging air to the cylinders of the combustion engine and the exhaust gas receiver will receive exhaust gas generated during the combustion process in the cylinders of the combustion engine. The air supply system 100 comprises one or more ADUs 20 for releasing compressed air to an outside of the hull 201 below a waterline of the vessel 200. The example air supply system 100 further comprises a pump 30 for generating a first flow f1 of sea water. The pump 30 may comprise an inlet 30A connected to a water source, such as to the water surrounding the vessel 200, and an outlet 30B for providing the first flow of water to be use by the air supply system 100. The example air supply system 100 further comprises an injector 40 comprising a first inlet 42 for receiving the first flow f1 of sea water from the pump 30, such as from the outlet 30B of the pump 30. The first inlet 42 may be a nozzle. The injector 40 comprises a second inlet 41 for receiving a second flow f2 of gas from the combustion engine. The second inlet 41 may also be a nozzle, such as a supersonic nozzle having a converging—diverging shape which generates an expansion of the second flow f2 of gas and partially converts enthalpy of the gas into kinetic energy. The second flow f2 of gas in this example embodiment is exhaust gas from the combustion engine. The exhaust gas may be received from the exhaust gas receiver or from an exhaust pipe of the engine. The injector 40 comprises an outlet 43 for discharging a third flow f3 of gas, such as a third flow of compressed gas, to the ADUs 20. The third flow of gas discharged from the injector 40 thus corresponds to the compressed gas provided to the ADUs 20. The injector 40 comprises an expansion portion 44 arranged downstream of the first inlet 42 and the second inlet 41 and upstream of the outlet 43. The injector 40 is configured to mix the first flow f1 of sea water and the second flow f2 of gas into the third flow f3 of gas. The expansion portion 44 of the injector is configured to expand the third flow f3 of gas to increase the pressure of the third flow f3 of gas discharged from the injector 40 through the outlet 43. The air supply system 100 is configured to evaporate the first flow f1 of sea water using thermal energy from the combustion engine so that the third flow f3 of gas is enriched with steam from the first flow f1 of sea water. In this example air supply system 100, the first flow f1 of sea water is evaporated in the injector 40 by the thermal energy from the second flow f2 of gas. In other words, the first flow f1 of sea water is evaporated when the first flow f1 of sea water comes into contact and mixes with the hot exhaust gas in the second flow f2 of gas in the injector 40.

The air supply system 100 may further comprise one or more turbochargers 10. Each turbocharger 10 may comprise a turbine 10A driven by an exhaust gas flow from the combustion engine, such as from the exhaust gas receiver, and a compressor 10B for generating a compressed scavenging air flow f4 to the combustion engine, such as to the scavenging air receiver of the engine. The air supply system 100 may further comprise an air cooler 15 for cooling the compressed air from the compressor of the each turbocharger, a water mist catcher 18 for removing moisture from the compressed air flow, and/or a non-return valve 19 for preventing contaminated air from the combustion process to flow from the scavenging air receiver backwards towards the turbocharger 10. The water mist catcher 18 may be arranged downstream of the air cooler 15. The non-return valve 19 may be arranged downstream of the water mist catcher 18. In order to prevent the turbocharger from overrevving, the air supply system 100 may comprise an exhaust gas bypass valve 9 for releasing exhaust gas in order to reduce the flow of exhaust gas to the turbocharger 10.

The air supply system 100 may comprise a changeover valve 13 arranged to open and/or close the second flow f2 of gas from the combustion engine. The air supply system 100 may further comprise a flow control device 12 arranged to control the second flow f2 of gas from the combustion engine. The flow control device 12 may be configured to ensure that only an amount of gas is extracted from the engine which ensures a sufficient gas flow to the engine that allows a correct operation of the engine. The flow control device may be an orifice, such as a passive orifice allowing a fixed amount of gas to flow from the engine to the injector or may be a variable orifice, such as a control valve, being configured to actively control the flow of gas to the from the engine to the injector. The variable orifice may e.g. be configured to be controllable to any position between fully open and fully closed to allow for a continuous control of the second flow f2 of gas. The air supply system 100 may further comprise a non-return valve 14 configured to prevent gas from flowing back from the injector 40, such as to prevent the flow f2 from flowing backwards from the injector towards the exhaust gas receiver.

The vessel 200 comprises the hull 201, the combustion engine and the air supply system 100 disclosed herein.

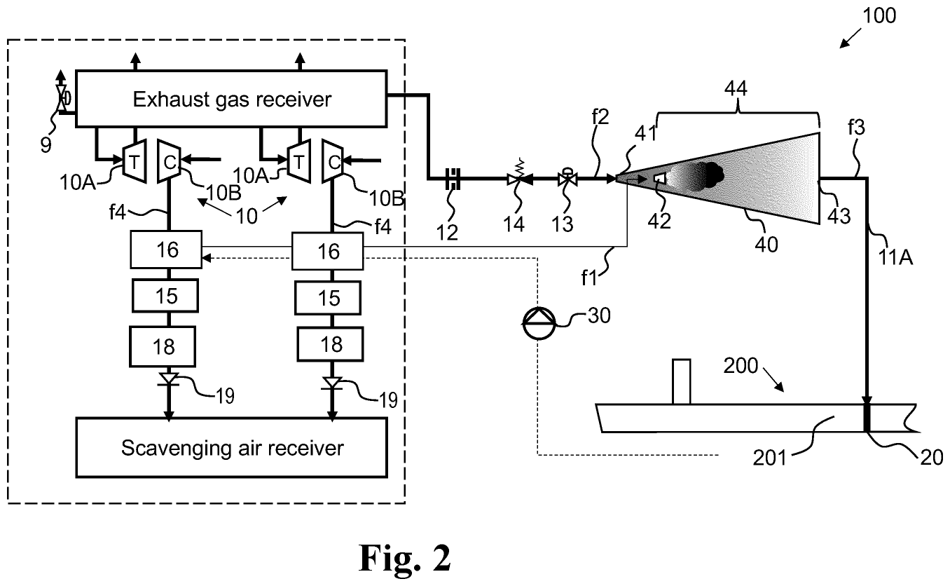

FIG. 2 illustrates an example air supply system 100 according this disclosure. The example air supply system of FIG. 2 differs from the example air supply system of FIG. 1 in that the air supply system 100 further comprises one or more WHR element(s) 16, such as an evaporator or an air to water intercooler, arranged in the compressed scavenging air flow f4 downstream of a respective compressor 10B of the one or more turbocharger(s) 10. The one or more WHR elements 16 are configured to increase the temperature of the first flow f1 of sea water by heat exchange with the compressed scavenging air flow f4 before the first flow f1 of sea water is received by the first inlet 42). The WHR elements 16 use the energy from the combustion process in the combustion engine that is not converted into useful work, such as thermal energy in the exhaust gas or the scavenging air to preheat the first flow f1 of sea water. The WHR elements 16 may thus transform the waste heat energy into useful energy for increasing the efficiency of the vessel 200. The first flow f1 of sea water may thus be fed to the WHR elements 16 from the outlet 30B of the pump 30. Upon passing through the WHR elements 16, the first flow of sea water is preheated by the thermal energy from the compressed scavenging air flow f4. By preheating the first flow f1 of sea water, an evaporation of the first flow f1 of sea water in the injector 40 is facilitated, since the thermal energy from the second flow f2 of gas required to evaporate the first flow f1 of sea water from the preheated stage is less than when the first flow of sea water is evaporated from an ambient temperature. The first flow of sea water may be fed to one or more WHR elements 16 arranged in respective scavenging air flows f4 of the engine. The first flow f1 of sea water may thus be preheated in a plurality of serial steps, where a first WHR element 16 performs an initial preheating, and a second WHR element performs a secondary preheating prior to the first flow f1 of sea water reaching the injector 40. When the first flow f1 of sea water reaches the injector 40 via the second inlet 42, the preheated first flow f1 of sea water is evaporated in the injector 40 by the thermal energy from the second flow f2 of gas, such as by the thermal energy from the exhaust gas of the engine.

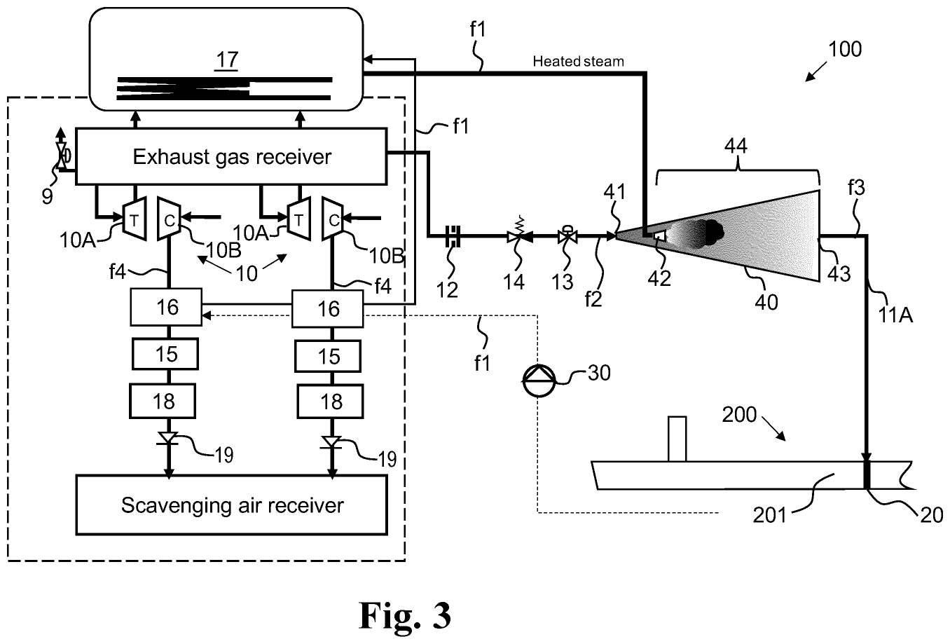

FIG. 3 illustrates an example air supply system 100 according this disclosure. The example air supply system of FIG. 3 differs from the example air supply system of FIG. 1 and of FIG. 2 in that the air supply system 100 further comprises one or more boilers 17 arranged in the first flow f1 of sea water. The one or more boilers 17 may be configured to increase the temperature and/or to evaporate the first flow f1 of sea water by heat exchange with exhaust gas from the combustion engine before the first flow of sea water is received by the first inlet 42 of the injector 40. The one or more boilers 17 may be water tube exhaust gas boilers with forced water circulation designed for heat recovery from engine exhaust gas. The one or more boilers 17 may comprise a heating element arranged downstream of the respective turbine(s) 10A of the one or more turbochargers 10 for receiving hot exhaust gas from the turbines 10A of the turbochargers. When the first flow f1 of sea water passes the heating element heat is transferred from the exhaust gas to the first flow f1 of sea water. The one or more boilers 17 may use the exhaust gas from the engine to produce steam, such as saturated steam, such as low-pressure saturated steam, from the first flow f1 of sea water. Whether the phase transition occurs, and the resulting gas/liquid mixture depends on several factors such as the pressure, temperature and volume of the sea water in the boilers 17. Saturated steam herein means a steam that occurs when the liquid and gaseous phases of water exist simultaneously. The first flow of sea water may then be provided to the injector 40 as steam, where the steam of sea water is mixed with the second flow f2 of gas from the engine, such as with the exhaust gas from the engine. When the steam of the sea water comes in contact with the second gas flow f2 in the injector, the remaining liquid water may be evaporated by the thermal energy from the second flow f2 of gas. In this example air supply system, the injector 40 may be a steam injector.

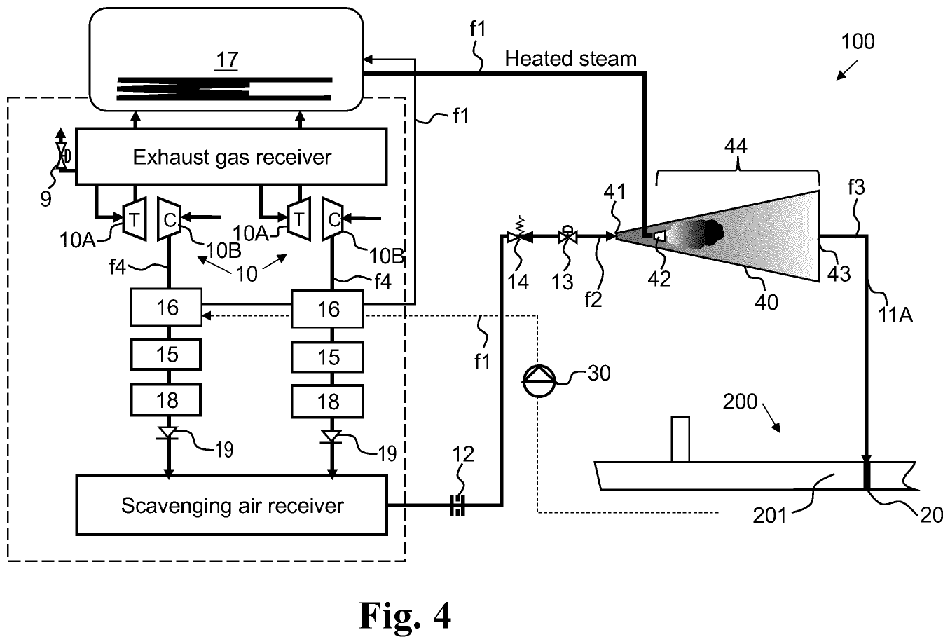

FIG. 4 illustrates an example air supply system 100 according this disclosure. The example air supply system of FIG. 4 differs from the example air supply system of FIG. 3 in that the gas of the second flow f2 is scavenging air for the combustion engine. The second flow f2 of air may be extracted from the scavenging air receiver or from the scavenging air flow f4. In some example air supply systems 100, the second flow of air may be extracted from between the air cooler 15 and the water mist catcher 18. The first flow f1 of water may pass through the one or more WHR elements 16, where the first flow f1 of water is preheated. The first flow f1 of water may then pass through the one or more boilers 17, where the first flow f1 of water is heated further and turned into steam, such as saturated steam, prior to entering the injector 40 via the first inlet 42. In the injector 40, the remaining liquid water may be evaporated by the thermal energy from the second flow f2 of gas, such as from the second flow f2 of scavenging air. Due to the temperature increase of the first flow f1 of sea water, when the first flow f1 of sea water passes through the WHR elements 16 and the one or more boilers 17, the thermal energy of the second flow f2 of scavenging air may be sufficient to evaporate the remaining liquid from the first flow f1 of steamed sea water. Using scavenging air has the benefit that the scavenging air is cleaner than the exhaust gas. In one or more example air supply systems 100 the second flow of air may be extracted from the scavenging air receiver or from the fourth air flow of scavenging air.

It shall be noted that the features mentioned in the embodiments described in FIGS. 1-4 are not restricted to these specific embodiments. Any features of the air release system and the components comprised therein and mentioned in relation to the air supply system of FIGS. 1-2, such as details of the scavenging air flow f4 or the WHR elements, are thus also applicable to the air supply systems described in relation to FIGS. 3-4.

It shall further be noted that a vertical axis, when referred to herein, relates to an imaginary line running vertically through the ship and through its centre of gravity, a transverse axis or lateral axis is an imaginary line running horizontally across the ship and through the centre of gravity and a longitudinal axis is an imaginary line running horizontally through the length of the ship through its centre of gravity and parallel to a waterline. Similarly, when referred to herein, a vertical plane relates to an imaginary plane running vertically through the width of the ship, a transverse plane or lateral plane is an imaginary plane running horizontally across the ship and a longitudinal plane is an imaginary plane running vertically through the length of the ship.

Embodiments of products (air supply system and vessel) according to the disclosure are set out in the following items:
Item 1. An air supply system (100) for supplying air to an outside of a hull (201) of a vessel (200) holding a combustion engine, the air supply system (100) comprising:
   one or more air discharge units, ADUs, for releasing compressed air to an outside of the hull (201) below a waterline of the vessel (200),
   a pump (30) for generating a first flow (f1) of sea water,
   an injector (40) comprising a first inlet (42) for receiving the first flow (f1) of sea water from the pump (30), a second inlet (41) for receiving a second flow (f2) of gas from the combustion engine, an outlet (43) for discharging a third flow (f3) of gas to the ADUs (20), and an expansion portion (44) arranged downstream of the first inlet (42) and the second inlet (41) and upstream of the outlet (43), wherein the injector is configured to mix the first flow (f1) of sea water and the second flow (f2) of gas into the third flow (f3) of gas and the expansion portion is configured to expand the third flow (f3) of gas to increase the pressure of the third flow (f3) of gas discharged from the injector (40) through the outlet (43),
   wherein the air supply system (100) is configured to evaporate the first flow (f1) of sea water using thermal energy from the combustion engine so that the third flow (f3) of gas is enriched with steam from the first flow (f1) of sea water.
Item 2. The air supply system (100) according to Item 1, wherein the gas of the second flow (f2) is an exhaust gas from the combustion engine.
Item 3. The air supply system (100) according to Item 1, wherein the gas of the second flow (f2) is scavenging air for the combustion engine.
Item 4. The air supply system (100) according to any one of the previous Items, wherein the first flow (f1) of sea water is evaporated in the injector (40) by thermal energy from the second flow (f2) of gas.
Item 5. The air supply system (100) according to any one of the previous Items, wherein the air supply system (100) comprises one or more turbochargers (10), each turbocharger (10) comprising a turbine (10A) driven by an exhaust gas flow from the combustion engine and a compressor (10B) for generating a compressed scavenging air flow (f4) to the combustion engine.
Item 6. The air supply system (100) according to Item 5, wherein the air supply system comprises one or more waste heat recovery element(s) (16) arranged in the compressed scavenging air flow (f4) downstream of a respective compressor (10B) of the one or more turbocharger(s) (10) and configured to increase the temperature of the first flow (f1) of sea water by heat exchange with the compressed scavenging air flow (f4) before the first flow (f1) of sea water is received by the first inlet (42).
Item 7. The air supply system (100) according to any one of the previous Items 5 or 6, wherein the air supply system (100) comprises one or more boilers (17) arranged in the first flow (f1) of sea water configured to increase the temperature and/or evaporate the first flow (f1) of sea water by heat exchange with exhaust gas from the combustion engine before the first flow of sea water is received by the first inlet (42).
Item 8. The air supply system (100) according to any one of the previous Items, wherein the air supply system comprises a changeover valve (13) arranged to open and/or close the second flow (f2) of gas from the combustion engine.
Item 9. The air supply system (100) according to Item 8, wherein the air supply system (100) comprises a flow control device (12) arranged to control the second flow (f2) of gas from the combustion engine.
Item 10. The air supply system (100) according to Item 9, wherein the flow control device (12) is an orifice or a control valve.
Item 11. The air supply system (100) according to any one of the Items 8 to 10, wherein the air supply system (100) comprises a non-return valve (14) configured to prevent gas from flowing back from the injector (40).
Item 12. A vessel (200) comprising a hull (201), a combustion engine and the air supply system (100) according to any one of the previous Items.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

What is claimed is:

1. An air supply system for supplying air to an outside of a hull of a vessel holding a combustion engine, the air supply system comprising:
one or more air discharge units, ADUs, for releasing compressed air to an outside of the hull below a waterline of the vessel,
a pump for generating a first flow of sea water,
an injector comprising a first inlet for receiving the first flow of sea water from the pump, a second inlet for receiving a second flow of gas from the combustion engine, an outlet for discharging a third flow of gas to the ADUs, and an expansion portion arranged downstream of the first inlet and the second inlet and upstream of the outlet, wherein the injector is configured to mix the first flow of sea water and the second flow of gas into the third flow of gas and the expansion portion is configured to expand the third flow of gas to increase the pressure of the third flow of gas discharged from the injector through the outlet,
wherein the air supply system is configured to evaporate the first flow of sea water using thermal energy from the combustion engine so that the third flow of gas is enriched with steam from the first flow of sea water.

2. The air supply system according to claim 1, wherein the gas of the second flow is an exhaust gas from the combustion engine.

3. The air supply system according to claim 1, wherein the gas of the second flow is scavenging air for the combustion engine.

4. The air supply system according to claim 1, wherein the first flow of sea water is evaporated in the injector by thermal energy from the second flow of gas.

5. The air supply system according to claim 1, wherein the air supply system comprises one or more turbochargers, each turbocharger comprising a turbine driven by an exhaust gas flow from the combustion engine and a compressor for generating a compressed scavenging air flow to the combustion engine.

6. The air supply system according to claim 5, wherein the air supply system comprises one or more waste heat recovery element(s) arranged in the compressed scavenging air flow downstream of a respective compressor of the one or more turbocharger(s) and configured to increase the temperature of the first flow of sea water by heat exchange with the compressed scavenging air flow before the first flow of sea water is received by the first inlet.

7. The air supply system according to claim 5, wherein the air supply system comprises one or more boilers arranged in the first flow of sea water configured to increase the temperature and/or evaporate the first flow of sea water by heat exchange with exhaust gas from the combustion engine before the first flow of sea water is received by the first inlet.

8. The air supply system according to claim 1, wherein the air supply system comprises a changeover valve arranged to open and/or close the second flow of gas from the combustion engine.

9. The air supply system according to claim 8, wherein the air supply system comprises a flow control device arranged to control the second flow of gas from the combustion engine.

10. The air supply system according to claim 9, wherein the flow control device is an orifice or a control valve.

11. The air supply system according to claim 8, wherein the air supply system comprises a non-return valve configured to prevent gas from flowing back from the injector.

12. A vessel comprising a hull, a combustion engine and the air supply system according to claim 1.
